(19) United States
(12) Patent Application Publication
(10) Pub. No.: US 2026/0300419 A1
(43) Pub. Date: Oct. 1, 2026

(54) INTELLIGENT HYBRID SEARCH AND RETRIEVAL

(71) Applicant: Intuit Inc., Mountain View, CA (US)

(72) Inventors: Neha KUMARI, Mountain View, CA (US); Rafael Pineros RHON, Mountain View, CA (US); Anurag SINGLA, Cupertino, CA (US); Pushparaj SHANMUGAM, San Jose, CA (US); Happy Bhairuprasad SOMANI, Mountain View, CA (US); Clinton NIELSEN, Mountain View, CA (US)

(73) Assignee: Intuit Inc., Mountain View, CA (US)

(21) Appl. No.: 19/094,695

(22) Filed: Mar. 28, 2025

(51) Int. Cl. G06F 16/9538

(52) U.S. Cl. CPC G06F 16/9538; G06F 16/2438; G06F 16/3346; G06F 16/9024

(57) ABSTRACT

A method includes processing a search query with an embedding model of a hybrid search engine to obtain a search query embedding. The search query is received from a user application. A hybrid search, including a lexical search and a semantic search, is performed with the search query and the search query embedding to obtain a search result set. The search result set is ranked based on hybrid search scores, user context data, and a user graph to obtain a ranked result set. The ranked result set is processed by a generative artificial intelligence model to obtain a ranking summarization and presented in the user application. User-preferred results of the ranked result set are captured based on user-selected facets of a facet navigation feature of the user application. The user context data and the user graph are updated based on the user-preferred results and the user-selected facets.

### BACKGROUND

Users with diverse occupations use search engines like Google®, Bing®, Baidu®, etc., globally, in multiple sessions daily. Since the advent of these search engines in the public domains of online content, their underlying algorithms have undergone several generational changes. The accuracy and recall of retrieved search results has resulted in a greatly enhanced search experience From the user's perspective, the experience may almost be likened to “reading the user's mind.”

As a result, the same quality of search experience and retrieved results are de facto expectations of users of software applications of specific application domains. Search functionality is integrated as an essential feature of diverse software applications in retail, finance, business, education, healthcare, etc. These software applications may connect to domain-specific, custom-built search engines. The search engines may typically perform lexical searches, the advantages of which are low latency and high accuracy. However, a technical problem arises when search processing is limited to lexical search. Often, users may not know how to articulate the search query to truly reflect the sought-after search result. Further, lexical search processing may not offer multi-lingual query capabilities. Additionally, lexical search cannot determine the intent of the search query.

### SUMMARY

In general, in one aspect, one or more embodiments relate to a method. The method includes processing a search query with an embedding model of a hybrid search engine to obtain a search query embedding. The search query is received from a user application. The method further includes performing a hybrid search with the search query and the search query embedding to obtain a search result set. The hybrid search includes a lexical search and a semantic search. The method further includes ranking the search result set, based on hybrid search scores, user context data, and a user graph to obtain a ranked result set. The ranked result set is processed by a generative artificial intelligence (GenAI) model to obtain a ranking summarization. The ranked result set is presented in the user application. The method further includes capturing, via a faceted navigation feature of the user application, user-preferred results of the ranked result set. The user-preferred results are obtained by filtering the ranked result set based on user-selected facets. The user context data and the user graph are updated based on the user-preferred results and the user-selected facets.

In general, in one aspect, one or more embodiments relate to a system. The system includes at least one computer processor, and a hybrid search engine, a result ranking engine, a GenAI model, and a SaaS application, each executing on the at least one computer processor. The system is configured for processing a search query with an embedding model of the hybrid search engine to obtain a search query embedding. The search query is received from a user application. The system is further configured for performing a hybrid search with the search query and the search query embedding to obtain a search result set. The hybrid search includes a lexical search and a semantic search. The system is further configured for ranking the search result set, based on hybrid search scores, user context data, and a user graph to obtain a ranked result set. The ranked result set is processed by the generative artificial intelligence (GenAI) model to obtain a ranking summarization. The ranked result set is presented in the user application. The system is further configured for capturing, via a faceted navigation feature of the user application, user-preferred results of the ranked result set. The user-preferred results are obtained by filtering the ranked result set based on user-selected facets. The user context data and the user graph are updated based on the user-preferred results and the user-selected facets.

In general, in one aspect, one or more embodiments relate to a method for ranking a set of search results. The method includes processing a search query with an embedding model of a hybrid search engine to obtain a search query embedding. The search query is received from a user application and generated by a user. The method further includes performing a hybrid search by the hybrid search engine with the search query and the search query embedding to obtain a search result set. The hybrid search includes a lexical search and a semantic search. The search result set includes lexical search results and corresponding lexical search scores, and semantic search results and corresponding semantic search scores. The method further includes determining, by a result ranking engine, hybrid search scores of the search result set based on the corresponding lexical search scores and the corresponding semantic search scores. The result ranking engine further extracts, from user context data, at least one feature of the user context data to obtain a feature set of the user context data. The user context data corresponds to the user that generated the search query. The method further includes processing the feature set of the user context data by a ranking model of the result ranking engine. The ranking model outputs a scaling factor based on the feature set of the user context data. The method further includes applying the scaling factor to hybrid search scores of the search result set to obtain scaled hybrid search scores of the search result set. The method further includes obtaining, by a graph-based adjuster of the result ranking engine, a set of first entities occurring in the search result set. The set of first entities is a subset of a set of second entities occurring in a user graph. The user graph corresponds to a user of the user application that generated the search query. For each first entity in the set of first entities, a connection analysis on user-to-entity connections and entity-to-entity connections of the user graph is performed to obtain multiplying factors for the set of first entities. A first node of the user graph corresponds to the user, and remaining nodes of the user graph correspond to the set of second entities. The multiplying factors are applied to the scaled hybrid search scores of the search result set to obtain ranking scores of the search result set.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a data flow diagram of factors used in scoring and ranking search recommendations and results, in accordance with one or more embodiments.

FIG. 3 shows a flowchart of a method for performing a hybrid search, in accordance with one or more embodiments.

FIG. 4 shows a flowchart of a method for performing a ranking of search recommendations and results, in accordance with one or more embodiments.

FIG. 5 shows an example of a hybrid search in an application, in accordance with one or more embodiments.

FIG. 6A and FIG. 6B show a computing system, in accordance with one or more embodiments.

Like elements in the various figures are denoted by like reference numerals for consistency.

### DETAILED DESCRIPTION

One or more embodiments are directed to intelligent hybrid search and retrieval of search results. The hybrid search combines lexical and semantic search processing of a search query. Semantic search processing alongside lexical search adds multi-lingual and intent search capabilities to search features in software applications. In combining the search processing, embodiments aggregate the search results obtained from the parallel methods of searching, using user context data within a software application to inform the selection, ordering, and summarization of the search results. The software application may be a user application in communication with a software-as-a-service (Saas) application, communicably coupled to a hybrid search engine.

The hybrid search engine receives the search query and invokes a generative artificial intelligence (GenAI) model to expand the search query. The GenAI model generates semantically equivalent terms for search terms in the search query, informed by domain and topic-specific context of the software application. The GenAI model uses the semantically equivalent terms to generate derived search queries of the original search query. Then, the hybrid search performs the lexical search alongside the semantic search of the search query as received, and the derived search queries to retrieve search results. In other words, the lexical search and semantic search are performed in parallel. The retrieved search results are selected and ranked based on lexical and semantic search scores converted to a hybrid search score. Additionally, adjustments and revisions are made to the ranking and selection of the search results using scaling and adjustment factors applied to the hybrid search scores of the retrieved search results. The scaling and adjustment factors may be obtained by processing user context data with a ranking model, and a knowledge graph of the user with a graph-based adjuster.

The user context data includes user profile information, current and past software application state context, and previous results selected, or preferred, by the user. The knowledge graph of the user is a graph model of past interactions of the user with system and business logic components of the software application.

The GenAI model then summarizes the revised ranked and selected search results search results, and presents explanations for the ranking of the result set. Additionally, the GenAI model may include certain results that may be “outliers” with respect to hybrid search scores, but may be relevant from the perspective of the user context data, knowledge graph, and global application context. The outliers included may be presented with natural language descriptions/explanations of the outliers.

As a result, the user may obtain relevant results notwithstanding that the search query may be articulated in a manner that does not reflect the actual intent of the search. Consequently, intelligent hybrid search may increase the user engagement and value of the software application.

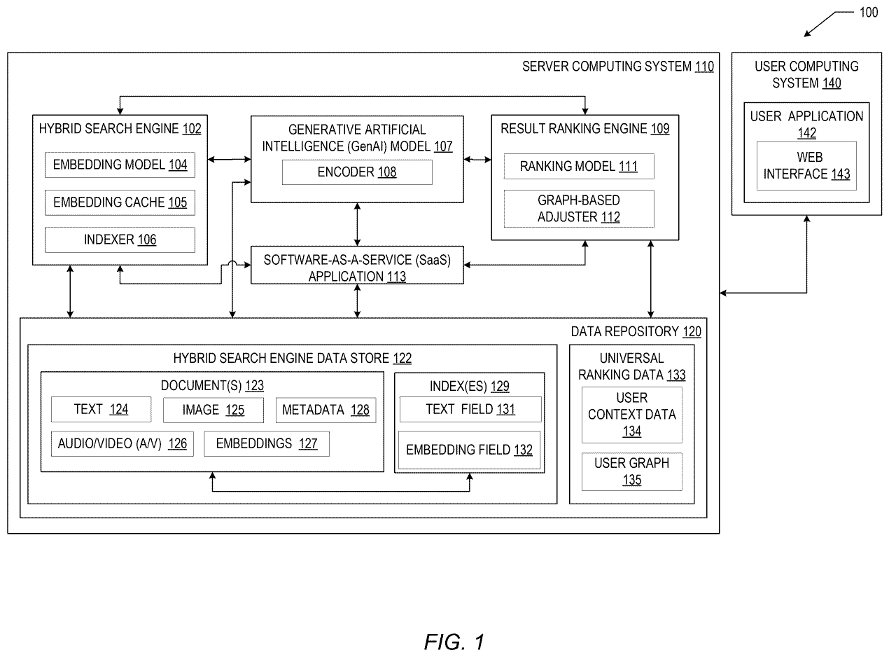

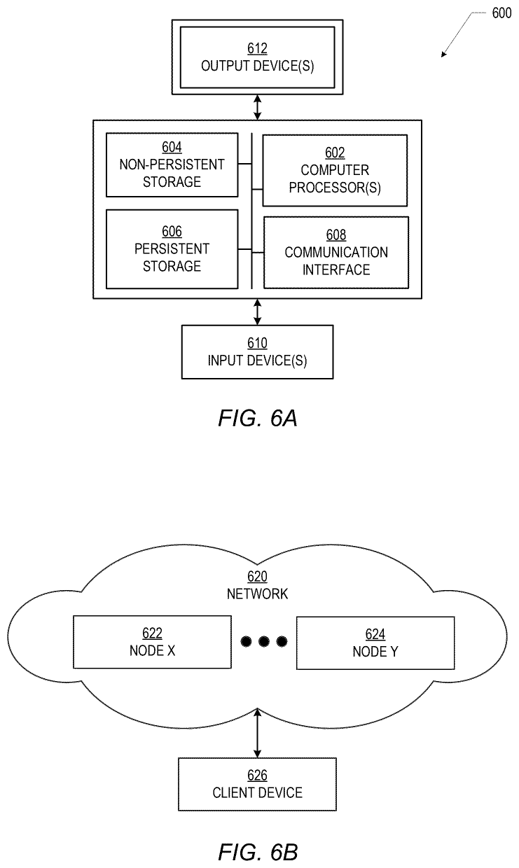

Attention is now turned to the figures. FIG. 1 shows a computing system (100), in accordance with one or more embodiments. The computing system (100) includes a server computing system (110) and a user computing system (140). The server computing system (110) is one or more computer processors, data repositories, communication devices, and supporting hardware and software. The server computing system (110) may be in a distributed computing environment. The one or more computer processors are one or more hardware or virtual processors which may execute computer readable program code that defines one or more applications, such as the hybrid search engine (102), the result ranking engine (109), the generative artificial intelligence (GenAI) model (107), or the software-as-a-service (SaaS) application (113). An example of the computer processor is described with respect to the computer processor(s) (602) of FIG. 6A. Thus, the server computing system (110) is configured to execute one or more applications, such as the hybrid search engine (102), the result ranking engine (109), the GenAI model (107), or the SaaS application (113). An example of a computer system and network that may form the server computing system (110) is described with respect to FIG. 6A and FIG. 6B.

The server computing system (110) shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) further includes a hybrid search engine data store (122). The hybrid search engine data store (122) further includes documents (123). The documents (123) may be in a machine-readable format, such as Javascript Object Notation (JSON). A document (123) may include diverse types of content. The content of a document (123) may include text (124), image(s) (125), and audio and/or video (A/V) (126). The document (123) may further include certain added fields, including metadata (128) fields, and vector fields that store embeddings (127). An embedding is a vector representation of document content. The structure and indexing of metadata (128) of a document (123) may be defined by mappings to ensure efficient querying and retrieval.

The hybrid search engine data store (122) further includes one or more index(es) (129). The index (129) is a logical structure that organizes and stores a collection of documents (123), that facilitates efficient searching, analysis, and retrieval. The index(es) (129) are generated based on mappings that define the structure and data types of the content within the documents.

As a general overview, mappings define how documents and their content are indexed and stored. Mappings provide a schema for the structure and data types of logical content in the documents. The mappings are used by an indexer (106) of the hybrid search engine (102) to generate corresponding fields within the index (129) for the particular logical content. For example, mappings may specify the data type of different logical content, such as text, keyword, number (integer or floating point), date/time stamps, Boolean, etc. Mappings may be explicitly defined, specifying the structure and data types of logical content before indexing documents. Further, mappings may be dynamically created by the hybrid search engine (102), such as by inferring the data type of a particular logical content, and adding a corresponding field to the index. Other types of nested and object fields may be defined and added to the index that correspond to compound, or complex logical content. Examples of compound or complex document content may include addresses, tables, user profile information, etc.

As shown in FIG. 1, the index (129) includes text field(s) (131). The text field(s) (131) are fields that are optimized for text indexing. The text field(s) (131) may correspond to text (124) in the document (123). In one or more embodiments, the text fields may be analyzed and tokenized to facilitate efficient full-text searches. The index (129) may further include embedding field(s) (132). The embedding field(s) (132) may correspond to embeddings (127) in the document (123). The embedding field(s) 132 may be optimized to support semantic searches, for example, K-nearest-neighbor (KNN) search. The embedding field(s) (132) may support similarity searches based on the semantic meaning of the document content. Other types of data types and fields of a document may also be mapped into the index (129).

The data repository (120) further includes universal ranking data (133). The universal ranking data (133) is data relating to various aspects of the user context of a user generating a search query. The universal ranking data may be used to rank some search results of a search query higher than other search results.

As a general overview, user context refers to the background information and surroundings that, when analyzed, may interpret a user's actions, preferences, and needs. The user may be the user of a user application (142) on a user computing device (140). User context includes various aspects that provide insight into a user's current activity, to make predictions about the user's desired outcomes. Further, a user's activity patterns may also be revealed through analysis of user context. Accordingly, the universal ranking data (133) includes context data associated with a user, namely, user context data (134).

User context data (134) may include the user search history, relating to the user's previous search queries. Frequently searched terms may be prioritized from the user search history. The user context data (134) may further include browsing history, and application interaction history of the user, e.g., the click-through rate of previous search results, historical clickstream data, and recent clickstream data. The session data of the user's current, and/or previous sessions may further be included in the user context data (134), e.g., application functional areas, ongoing workflows, active tabs, active pages, etc. Further, the user context data (134) may include user-specific information, such as language preferences and location. The user context data (134) may further include keywords and phrases extracted from the content of the application that the user is currently viewing or interacting with.

The universal ranking data (133) may further include user graph(s) (135). The user graph(s) (135) are knowledge graphs. As a general overview, a knowledge graph is a way of representing information in a graph of nodes and edges. Nodes may represent entities (such as the user, other users/clients/customers/people, places, or objects, or activities) and edges may represent the relationships between those entities. Knowledge graphs may serve to model a user's connections with entities in an application domain space. Based on this model, some search results may be ranked higher than others as being more relevant to the user's connections to entities and corresponding relationships.

Accordingly, the user graph (135) is a knowledge graph of entities associated with a user within an application domain space. The application domain space may include shared domains of related applications. A node in the user graph (135) may represent the user or a possible entity with which the user may interact. Nodes are connected by edges having weights. The weights of the edges are based on the degree of connectivity between the user and the corresponding entity. The entity may be another actor in the application domain space, for example, a customer, or a vendor. The entity may be a business logic component of the application, such as an invoice, a payment, inventory, etc. Each user may have at least one corresponding knowledge graph that is specific to the user, that is, the user graph (135).

By way of example, in a business accounting and finance application, a knowledge graph for a user may include the user, namely an employee or business owner of the enterprise running the application. The knowledge graph may further include entity nodes including, invoices representing invoices issued by the user, payments representing payments received or made, and customers representing customers and clients. The knowledge graph may further include respective entity nodes for vendors representing suppliers and vendors, transactions representing expenses and income, and accounts, representing bank accounts and credit cards, etc. The edges, or relationships, may include “Issued” as the relationship between the user and the invoices, “Paid” as the relationship between invoices and payments, “Provided” as the relationship between the users and the customers, etc. The edges may have corresponding weights, such as number of invoices issued for the “Issued” edge. Attributes of the nodes and/or edges may include payment amounts, invoice dates, customer contact information, transaction type, account balance, etc.

The server computing system (110) includes a hybrid search engine (102). The hybrid search engine (102) is software or application specific hardware, which, when executed by the one or more computer processors, performs searches that blend various methodologies including full-text searches, structured query processing, semantic searches across data in different formats, such as text, images, and A/V. The hybrid search engine (102) performs lexical searches and semantic searches. The lexical searches may include full-text searches for unstructured data, and structured queries for database-like searches. The semantic search may entail the use of embeddings and a KNN search to find similar content based on meaning. The hybrid search engine (102) may have multi-format data handling capacity. Examples of hybrid search engines include Opensearch®, Elasticsearch®, etc.

The hybrid search engine (102) includes an embedding model (104). The embedding model (104) is software or application specific hardware, which, when executed by the one or more computer processors, generates vector embeddings, referred to herein as “embeddings,” of content. Content may include text, images, A/V, numbers, etc. More specifically, an embedding model is a machine learning model which transforms data provided as input into vector representations, namely, embeddings, in a continuous high-dimensional space. Embeddings capture the semantic meaning and relationships of data, facilitating comparison and similarity searches. Examples of embedding models include Bidirectional Encoder Representations from Transformers (BERT), FastText, Word2Vec, etc. Other multi-modal embedding models that generate embeddings for text, image, and A/V data may be used.

The hybrid search engine (102) further includes an embedding cache (105). The embedding cache (105) is a storage mechanism that holds precomputed data (embeddings) to speed up future computations. The embedding cache (105) may be provided as an in-memory caching service. Examples of in-memory caching services include DynamoDB® accelerator (DAX) from Amazon®, etc.

The hybrid search engine (102) further includes an indexer (106). The indexer (106) is software or application specific hardware, which, when executed by the one or more computer processors, ingests data from various sources and extracts information from the ingested data based on a mapping. The information may include keywords, phrases, metadata, multi-media data attributes, etc. The indexer (106) generates fields that include the extracted information in the index(es) (129). Thus, the indexer (106) may generate both text fields (131), and embedding fields (132) of the index (129).

The server computing system (110) further includes a GenAI model (107). In one or more embodiments, the GenAI model (107) may be a large language model (LLM). Examples of LLMs include ChatGPT®, Llama®, Claude®, etc. In other embodiments, the GenAI model (107) may a custom-built model based on a foundation model. Foundation models are deep learning models that may be trained on vast datasets for applications in natural language processing, image processing, speech recognition, etc. Foundation models may be used for generative AI tasks in natural language processing, such as translation, summarization, sentiment analysis, transfer learning, etc. Examples of off-the-shelf AI models built on foundation models include the aforementioned LLM examples. Further, foundation models may be used in image generation, for interpreting text to generate an image. DALL-E is an example of an image-generative GenAI model.

Foundation models may serve as building blocks for more specialized AI applications. For instance, enterprises offering retail software-as-a-service (Saas) applications may use a foundation model and retrain, or fine-tune, the foundation model on domain-specific data to obtain a specialized GenAI model that serves the SaaS applications. For example, GenAI models in finance SaaS applications may analyze transaction data in real-time to detect or prevent fraudulent activities. As another example, GenAI models may be used in tax-preparation applications to automate and enhance tax content generation, and document processing. GenAI models may be used in e-commerce SaaS platforms for personalized product listings and dynamic pricing.

The GenAI model (107) includes an encoder (108). The encoder (108) is machine learning model that processes an input sequence by generating a set of encoded representations. The set of encoded representations capture the context and relationships between the elements of the sequence. In natural language processing, the encoder (108) may convert text into meaningful vector representations for tasks like translation, sentiment analysis, and text generation such as synonyms, related sentences, etc. The encoder (108) may generate encoded representations of the search query. Further, the GenAI model (107) may use the encoded representations to generate synonyms, topic-specific expanded terms, and context-specific expanded terms. Additionally, the GenAI model (107) may generate derived search queries using the synonyms and expanded terms.

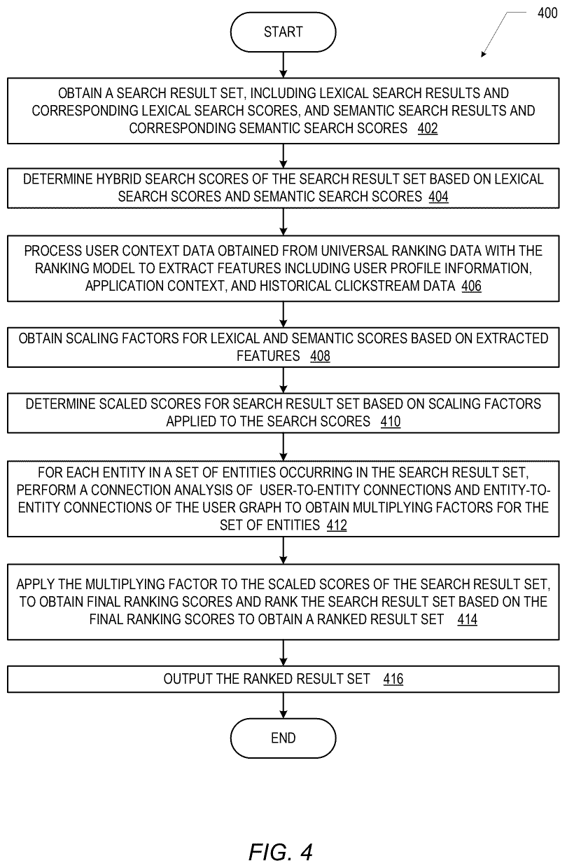

The server computing system (110) further includes a result ranking engine (109). The result ranking engine (109) is software or application specific hardware, which when executed by the one or more computer processors, ranks search results generated by the hybrid search engine (102) based on the universal ranking data (133). More specifically, the result ranking engine (109) ranks the search results by processing the search results with a ranking model (111), and a graph-based adjuster (112). The ranking model (111) is a machine learning model that uses lexical search scores and semantic search scores of the search results to rank the search results. Examples of the ranking model (111) may include multi-layered perceptron neural networks, recurrent neural networks, graph neural networks, hybrid models, etc. A detailed description of the working of the ranking model (111) is provided in reference to FIG. 4.

The graph-based adjuster (112) of the result ranking engine (109) is configured to adjust the ranked search results obtained from the ranking model based on the user graph (135). For example, for any entities found in the search results that also occur in the user graph, the weights of the connections in the user graph between these entities, or between the user and the entities, are used to adjust the search result scores. In one or more embodiments, the score may be a weighted average of the score and the weights. Other computations may be used. Thus, the output of the graph-based adjuster may be a revised or otherwise adjusted version of the ranked search result. A detailed description of the working of the graph-based adjuster is provided in reference to FIG. 4.

The server computing system (110) further includes one or more SaaS application(s) (113). A SaaS application is a software application with a delivery model of applications hosted on remote servers and accessed by users over a communication network. The SaaS application(s) (113) may be accessed through the web interface (143) of the user application (142). In certain embodiments, the SaaS applications (113) may remotely manage the user application (142) storage requirements, and other business logic. More particularly, the SaaS application (113) may provide hybrid search functionality to the user application (142) as at least one of the user application features.

By way of example, the SaaS application (113) may be a business finance and accounting application. The user application (142) may access the SaaS application (113) over a communication network. A feature in the user application (142) may be a search window, or search page of the web interface (143). When the user types a search query into the web interface (143), the user application (142) may access the SaaS application (113) via the communications network. The SaaS application (113) may programmatically invoke the hybrid search engine (102) to perform the search for the search query.

The system (100) includes a user computing system (140). The user computing system (140) is a computing system used by a user to submit a user query. The user computing system (140) may include a display for displaying the web interface (143) of a user application (142) and an input device for receiving input from the user. The user computing system (140) may further include a network interface for connecting the user computing system (140) to the server computing system (110). The user computing system (140) may be configured to execute the user application (142) with the web interface (143). In one or more embodiments, the user application (142) may be a web-based client application, operating within a web browser. Other embodiments of the user application (142) may include native desktop applications, mobile applications, remote desktop clients, etc. The user application (142) may be serviced by one or more SaaS applications (113) executing on the server computing system (110). For example, the SaaS application (113) may be an office productivity based application (e.g., Office 365®), a graphics based application, a financial application (e.g., QuickBooks®), a multi-media application, or other type of application.

While FIG. 1 shows a configuration of components, other configurations may be used without departing from the scope of one or more embodiments. For example, various components may be combined to create a single component. As another example, the functionality performed by a single component may be performed by two or more components.

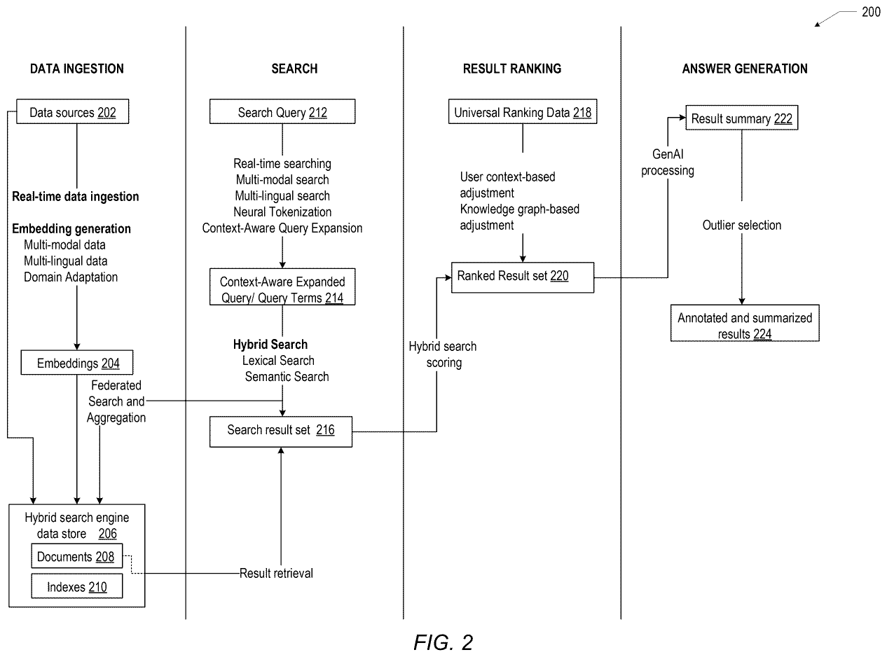

FIG. 2 shows a data flow diagram of the processes of data ingestion, search, result ranking, and answer generation performed by the system of FIG. 1. FIG. 2 includes the various operations performed by the system of FIG. 1 on the data in diverse processing steps of a given process. The various operations may be performed on the data in one or more of the processes of FIG. 2. In FIG. 2, the data is shown in the labeled blocks, and the operations that may be performed on the data are shown as annotations of the block connectors.

In the ingestion process, data may be ingested from one or more data sources (202). Data may be ingested in real-time, as an ongoing background operation in the system of FIG. 1. The operation of real-time ingestion may entail the ingestion and indexing of a large amount of data in documents. Real-time ingestion may further entail the large scale computation of embeddings of the data. In this way, a hybrid search may yield search results indexed and obtained in real-time.

Embeddings (204) may be generated for the data from the data sources (202). The embedding model of the system of FIG. 1 may generate embeddings for multi-modal and multi-lingual data. That is, the embedding model may be a multi-lingual embedding model. Further, the embedding model may include multi-modal data processing functionality. Further, the embedding models may be adapted to particular domains by fine-tuning the embedding models using domain-specific ontologies, knowledge bases, and specialized vocabularies.

The embeddings (204) and data from the data sources (202) may be stored in the hybrid search engine data store (206), which corresponds to the hybrid search engine data store (122) of FIG. 1. The embeddings (204) and data from the data sources (202) may be stored in documents (208), and indexed in the indexes (210).

In the search process, a search query (212) may be received as an initiation of the search process. The system of FIG. 1 may be configured to receive search queries in multiple languages, and in multiple modalities, e.g., text, speech, images, etc. In a context-aware query expansion operation, the system of FIG. 1 may generate multiple searches based on the search query by dynamically expanding or refining the search query. The expanded terms or search query refinements may be informed by analyzing user context, role, recent activities, and domain-specific terminology. The GenAI model of FIG. 1 may convert the search query into multiple searches or a single refined and/or expanded search query. More particularly, in a neural tokenization operation, the encoder of the GenAI model of FIG. 1 may tokenize a text search query and generate encoded representations of the query. These encoded representations may be used by the GenAI model to expand the query. For example, the term “car mechanic” may be expanded to “car,” “vehicle,” “repair,” “mechanic,” and “service,” to increase recall. The encoder may be fine-tuned on domain-specific ontologies to provide meaningful and relevant term expansions.

The pre-processing of the search query may result in context-aware expanded query/query terms (214). A hybrid search operation, including a lexical search and a semantic search, may be performed on the context-aware expanded query/query terms (214). In other words, the system of FIG. 1 may use keyword-based and semantic search methods to retrieve and rank results. In performing the hybrid search operation, the system of FIG. 1 may perform a federated search and aggregation operation. Namely, the system of FIG. 1 may transmit the search query to multiple instances of the hybrid search engine of FIG. 1. The multiple instances of the hybrid search engine may access disparate hybrid search engine data stores including data ingested from multiple application domains, external data sources, etc. Further, user context data from the multiple application domains may be retrieved for the result ranking process. The results may be retrieved from the hybrid search engine data store(s) (206) to obtain the search result set (216).

In the result ranking process, universal ranking data (218) may be retrieved by the result ranking engine of FIG. 1. The universal ranking data (218) of FIG. 2 corresponds to the universal ranking data (133) of FIG. 1. The result ranking engine may further retrieve hybrid scores of the search results (216) and perform a user context-based adjustment operation of the hybrid scores of the search results (216). Further, the result ranking engine may perform a user graph-based adjustment operation on the search results (216) to obtain the ranked result set (220). A detailed description of the user context-based adjustment operation and the knowledge graph-based adjustment operation is provided in reference to FIG. 4.

In the answer generation process, the ranked result set (220) may undergo processing by the GenAI model of FIG. 1. The GenAI model may generate a result summary (222) of the result set. Further, the result set may be annotated with explanations of the ranking and inclusion of individual results of the result set. In the search operation, clusters of results may be identified in the data that are together. Further, outlier results may be selected. In the answer generation process, the outlier results may be summarized and presented to the user as alternate results (e.g., with a “were you looking for . . . ” or “did you mean . . . ,” annotation) in the outlier selection operation. The final set of annotated and summarized results (224), including the outlier results, is shown in FIG. 2. These results may help the user to redirect the search query in case the user does not find relevant documents after repeated searches.

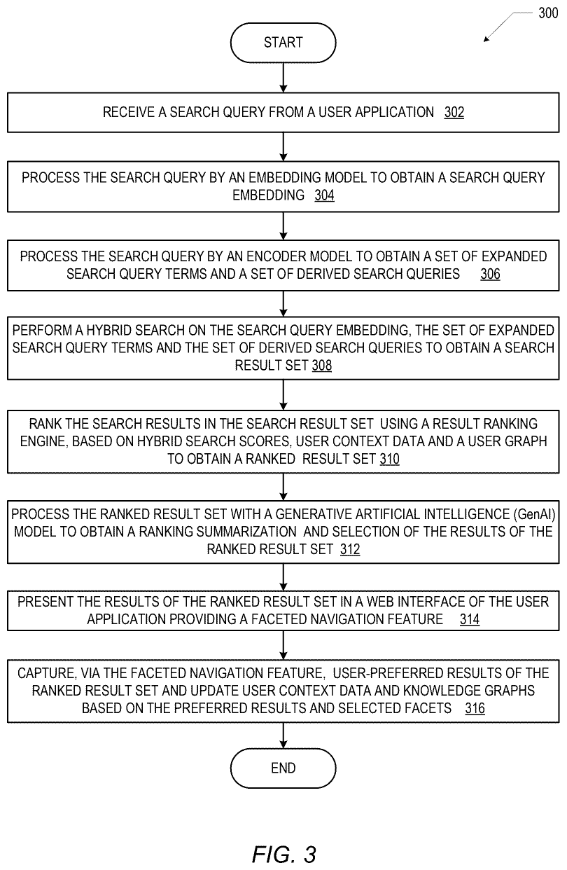

FIG. 3 shows a flowchart 300 of a method for performing a hybrid search incorporating real-time and previous user context, in accordance with one or more embodiments. The method of FIG. 3 may be implemented using the system of FIG. 1 and one or more of the steps may be performed on or received at one or more computer processors. While the various steps in the flowchart 300 are presented and described sequentially, at least some of the steps may be executed in different orders, may be combined, or omitted, and at least some of the steps may be executed in parallel. Furthermore, the steps may be performed actively or passively.

In Block 302, a search query is received from a user application. In one or more embodiments, the SaaS application of FIG. 1 may receive the search query from the user application. Further, the SaaS application may programmatically invoke the hybrid search engine to process the search query.

In Block 304, the search query is processed by an embedding model to obtain a search query embedding. In one or more embodiments, the embedding model of the hybrid search query engine may process the search query to generate the search query embedding. The search query embedding may be used in conjunction with the search query to perform the hybrid search. The embedding model may generate search query embeddings of the search query which may be in a different language from the document content of the hybrid search engine data store associated with the hybrid search engine. For example, the search query may be in Spanish. Nevertheless, the search query embedding may map to vector embeddings in the hybrid search engine data store that were generated from content in English that has the same semantic meaning. Further, the embedding model may generate search query embeddings of text, A/V, speech, and image data.

In Block 306, the search query is processed by an encoder model to obtain a set of expanded search query terms and a set of derived search queries. In one or more embodiments, the hybrid search engine may programmatically invoke the GenAI model to generate the set of expanded search query terms and a set of derived search queries. More specifically, in one embodiment, the hybrid search engine may provide a prompt to the GenAI model with the search query and/or the search query embedding as an input. The hybrid search engine may further provide an instruction to generate expanded search query terms and the set of derived search queries. Additional inputs of the prompt may include user context data obtained from the universal ranking data. The user context data may further inform the GenAI model of the scope of generating the expanded search query terms. The GenAI model thus performs the context-aware query expansion operation shown in FIG. 2.

In Block 308, a hybrid search is performed on the search query, the search query embedding, the set of expanded search query terms, and the set of derived search queries to obtain a search result set. In one or more embodiments, the hybrid search includes a lexical search and a semantic search.

The lexical search operation may entail the use of a keyword-based algorithm. The search query may be parsed to identify the keywords, and tokenized into individual terms. In selecting a document from the hybrid search store as a possible match source, the hybrid search engine may calculate a term frequency measuring how often each term appears in a document. Documents with higher occurrences of the search terms may be considered more relevant. An inverse document frequency may further be calculated, giving less weight to common terms, in an effort to emphasize more unique terms. A relevance score may be generated for each document including the search terms. In one or more embodiments, an algorithm such as the BM25 algorithm may be used. The documents may be ranked based on their relevance scores and returned as a list of lexical search results. The relevance scores may constitute the lexical scores of the lexical search.

The semantic search operation may entail comparison of the search query embedding to embeddings in the document. In one or more embodiments, a KNN search may be performed, using a similarity measure, e.g., a cosine similarity, or Euclidean distance. Documents with embeddings that are closest to the search query embedding may be considered the most relevant. The documents may be ranked based on the similarity scores and returned as a list of semantic search results. The similarity scores may constitute the semantic scores of the semantic search. The list of lexical search results and the list of semantic search results may be combined, or aggregated, to obtain the search result set. Other semantic search algorithms and similarity measures may be used.

In one or more embodiments, the hybrid search may be performed as a federated search, with a multitude of hybrid search engine instances, to obtain a multitude of federated search results. The multitude of federated search results from individual hybrid search engine instances may be aggregated to obtain the search result set. An individual hybrid search engine instance may access a corresponding individual hybrid search engine data store, or internal and external data sources related to the same application domain space, or related application domain spaces of the particular user. The application domain spaces may be diverse application domains serving diverse SaaS applications hosted by the enterprise. For example, a user may use a business finance and accounting application. The user may also be a paying customer of a tax planning application. Depending on the search query, expanded search terms, and expanded search queries, a federated search may be performed.

In Block 310, the search results in the search result set may be ranked using the result ranking engine, based on hybrid search scores, user context data, and a user graph, to obtain a ranked result set. In one or more embodiments, the steps of Block 310 may be implemented in accordance with the method of FIG. 4. A detailed description of the method of FIG. 4 is provided in reference to FIG. 4.

In Block 312, the ranked result set is processed with the GenAI model to obtain a ranking summarization, and a selection of the results of the ranked result set. In one or more embodiments, the GenAI model may process the documents of the ranked result set to generate a summarized version of the results. Further, individual results of the ranked result set may be annotated with a succinct explanation of the ranking and inclusion of the individual result in the ranked result set. Additionally, the GenAI model may be provided with outlier results by the hybrid search engine. The outlier results may represent documents that may be more relevant to the user context than the actual search query. The outlier results may be selected by the GenAI model for presentation to the user.

In Block 314, the results of the ranked result set may be presented in a web interface of the user application. Further, the user application may provide a faceted navigation feature. Faceted navigation features of user applications facilitate user filtering and refining of search results based on multiple attributes, or facets. Facets are categories or attributes that characterize the search results of a search result set. In filtering the results, a user may select one or more facets to narrow down the search results. As the user selects or deselects facets, the search results may update dynamically to reflect the selected filters. In one or more embodiments, the ranked result set may be presented in the user application.

In Block 316, user-preferred results of the ranked result set are captured, via the faceted navigation feature. Additionally, the user context data and user graphs are updated based on the user-preferred results and selected facets. In one or more embodiments, user-preferred results of the ranked result set may be captured, via a faceted navigation feature of the user application. The user-preferred results of the ranked result set may be obtained by filtering the ranked result set based on user-selected facets. Further, the user context data and the user graph may be updated based on the user-preferred results and the user-selected facets, for subsequent search queries entered by the user.

If the user-preferred results include a higher proportion of lexical search results than semantic search results, then the embedding model may be fine-tuned based on the user-preferred results for better contextual matching. As described previously, the embedding model may be a multi-lingual and multi-modal embedding model.

In one or more embodiments, data pre-processing, entailing data ingestion into the hybrid search engine data store and indexing of the ingested data may be a process occurring prior to the execution of the method of FIG. 3. In one or more embodiments, data pre-processing may entail ingesting, in real-time, raw data from a multitude of data sources by the hybrid search engine. Further, the embedding model of the hybrid search engine may generate embeddings of the raw data. The raw data may be added to a document in a machine-readable file format (e.g., JSON). The document may include data fields corresponding to the raw data (e.g., text, image, A/V fields) and vector fields corresponding to the embeddings of the raw data. A multitude of documents may be obtained in this manner. Further, an indexer of the hybrid search engine may generate a corresponding index of the multitude of documents. The index may include text fields and embedding fields. The multitude of documents and indexes may be stored in the hybrid search engine data store.

In this manner, by dynamically updating user context data, and the user graph, the system of FIG. 1 implementing the method of FIG. 3 facilitates a real-time hybrid search. The real-time result selection is informed by user context. The user context is also updated in real-time, increasing the likelihood of user's continued usage of the search capability of the user application to achieve a desired outcome.

FIG. 4 shows a flowchart 400 of a method for ranking a search result set based on user context data and a user graph. The method of FIG. 4 may be implemented using the system of FIG. 1 and one or more of the steps may be performed on or received at one or more computer processors. While the various steps in the flowchart 400 are presented and described sequentially, at least some of the steps may be executed in different orders, may be combined, or omitted, and at least some of the steps may be executed in parallel. Furthermore, the steps may be performed actively or passively.

In Block 402, a search result set, including lexical search results and corresponding lexical search scores, and semantic search results and corresponding semantic search scores is obtained. In one or more embodiments, the result ranking engine may obtain the search result set from the hybrid search engine.

In Block 404, hybrid search scores of the search result set based on lexical search scores and semantic search scores are determined. In one or more embodiments, diverse techniques may be used to determine the hybrid search scores. One technique may be a linear combination function that uses the weighted sum of the lexical and semantic scores based on a balance parameter. The balance parameter may control the balance (weightage assigned) between a lexical and a semantic score of a search result. Another technique may be a geometric mean. Harmonic mean is yet another technique that may be used to improve the significance of lower scores. In one or more embodiments, a machine learning model may be used to learn the optimal combination of lexical and semantic scores based on historical data, for example, a linear regression machine learning model.

In Block 406, user context data obtained from the universal ranking data is processed by the ranking engine to extract features of the user context data. The features may include user profile information, application context, and historical clickstream data.

As a general overview, the application context may include information related to a particular instance of the user application and corresponding context information of the particular instance managed by the SaaS application. Additionally, the application context may include information related to multiple instances of the user application, and corresponding context information, managed by the SaaS application. The multiple instances of the user application may be instantiated by diverse users across multiple user computing systems. The application context of a particular instance of the user application may include page context, session context, and recent clickstream data. The application context may further include past interactions with previous search results and click-through rate of each previous search result. Additionally, the application context may include information obtained from the SaaS application related to other instances of the application. For example, past interactions with search results for users with similar user profile information.

In one or more embodiments, the result ranking engine may extract at least one feature of the user context data, from the user context data, to obtain a feature set of the user context data. The user context data may correspond to a user of the user application that generated the search query, as described in Block 302 of the method of FIG. 3.

In Block 408, scaling factors for lexical and semantic scores are obtained, based on extracted features. In one or more embodiments, the extracted features may be included in the feature set obtained in Block 406. In one or more embodiments, the feature set of the user context data may be processed by the ranking model of the result ranking engine. Further, the ranking model may output a scaling factor, based on the feature set of the user context data. In one or more embodiments, the ranking model may be trained to learn the scaling factor based on the feature set of the user context data.

In Block 410, scaled scores for search result sets are determined, based on scaling factors applied to the search scores. In one or more embodiments, the scaling factor may be applied to hybrid search scores of the search result set to obtain scaled hybrid search scores of the search result set. Additionally, the scaling factor may be obtained from feature analysis of the feature set by the ranking model. The scaling factor may be adjusted by an asynchronous periodic analysis of relative lexical search and semantic search scores for search results of a search query. The scaling factor may be further adjusted by the user and click-through rate of the corresponding search results corresponding to higher values of the lexical score or the semantic score.

In Block 412, for each entity in a set of entities occurring in the search result set, a connection analysis is performed on the user graph. The connection analysis may include connection analysis of user-to-entity connections and entity-to-entity connections of the user graph. A set of multiplying factors may be obtained for the set of entities.

In one or more embodiments, the graph-based adjuster of the result ranking engine may obtain a set of first entities occurring in the search result set. The set of first entities may be a subset of a set of second entities occurring in the user graph. Further, the user graph may correspond to a user of the user application that generated the search query. For each first entity in the set of first entities, a connection analysis may be performed on user-to-entity connections and entity-to-entity connections of the user graph. In the user graph, a first node of the user graph may correspond to the user. Remaining nodes of the user graph may correspond to the set of second entities. Multiplying factors for the set of first entities may be obtained from the connection analysis.

In the search result set, individual search results may relate to entities that also occur in the user graph of the user that generated the search query. For example, if the user entered a search query “Invoices in February 2025 sent to Customer X YZ,” or, “Invoices in February 2025 from Vendor A BC,” the entities co-occurring in the search result set and the user graph may be Invoices, Customer, and Vendors. Additionally, the user graph may also include entities such as Payments, Monies Received, Accounts, etc. Thus, the entities in the search result, namely, Invoices, Customer, and Vendors, are a subset of the entities in the user graph, which includes the additional entities of Payments, Monies Received, Accounts, etc. Continuing with the example, in the connection analysis, the connections of the entities Invoices, Customer, and Vendors of the user graph may be analyzed with respect to the user, and with respect to one another.

Connection analysis may entail a determination of entities referenced in the search result set that are also represented by nodes in the user graph, to identify a set of co-occurring entities. That is, the entities referenced in the search result set are also represented by nodes in the user graph corresponding to the particular user. The edges between the user node and the co-occurring entity nodes of the user graph may be traversed to calculate the sum of weights between the user node and each co-occurring entity node. In a similar manner, the edges between the co-occurring entity nodes may be traversed to calculate the sum of weights between the co-occurring entity nodes. The sums may constitute the multiplying factors obtained from the connection analysis.

In Block 414, the multiplying factors are applied to the scaled scores of the search result set obtained in Block 410, to obtain final ranking scores. Further, the search result set is ranked based on the final ranking scores to obtain a ranked result set. In one or more embodiments, the multiplying factors obtained from Block 412 may be applied to scaled hybrid search scores of the search result set (obtained in Block 410) to obtain ranking scores. The search result set may be ordered based on the ranking scores to obtain the ranked result set. In Block 416, the ranked result set is outputted by the result ranking engine. In one or more embodiments, the ranked result set may be further processed by the GenAI model in accordance with Block 312 of the method of FIG. 3.

The user response to the ranked search results may be monitored and user context data may be updated accordingly. Further, the edge weights of the user graph may be updated based on user interactions with the search results and with the user application. The updates may be performed in real-time, or periodically. For example, if a customer of the user places a series of orders in a given month, then the user graph will be updated to increase the weightage of the connection between the user and the particular customer.

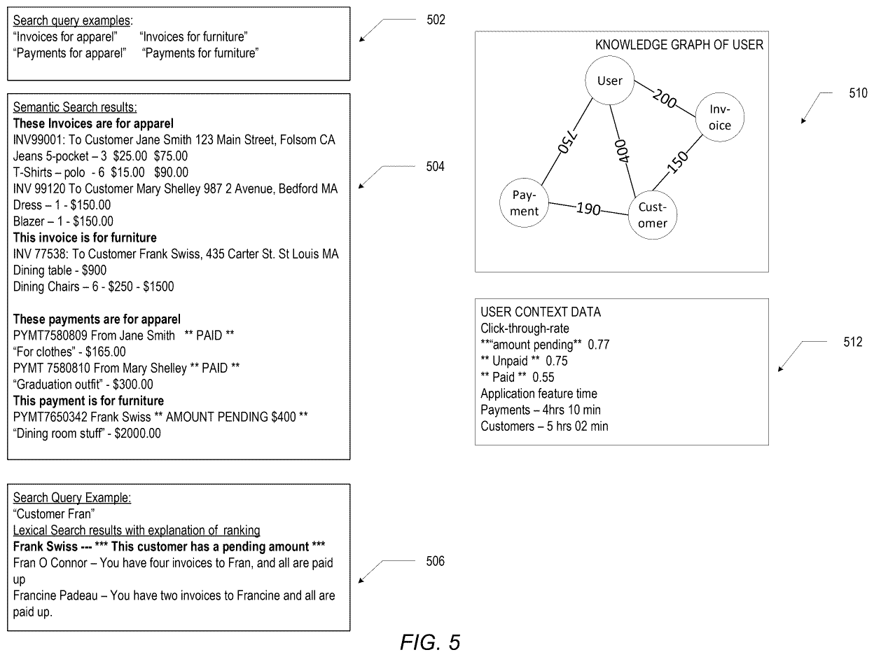

FIG. 5 shows an example of a search query, and result sets obtained by performing a hybrid search. The example of FIG. 5 further shows weighting the results based on user context data and user graphs, in accordance with one or more embodiments. The following example is for explanatory purposes only and not intended to limit the scope of one or more embodiments.

Block 502 shows some examples of search queries. The queries include generalized terms “apparel” and “furniture.” Notably, these generalized terms may not feature on invoice line items, as typically, invoice items may include SKU numbers, specific names of clothing/furniture items, such as “T-shirt,” “jeans,” “dress,” “dining table,” etc.

Block 504 shows an example of search results returned by the hybrid search engine. More specifically, the search results shown are examples of a semantic search result subset of the set of search results. The GenAI model summarizes the results under the generalized terms of “apparel” and “furniture.” Notably, the search results do not include the aforementioned terms. Instead, the search results relate to types of apparel and types of furniture. Thus, by neural tokenization of the search terms by the encoder of the GenAI model, synonyms, and related terms by topic of the search query are searched by the hybrid search engine.

Block 506 shows a different search query example, namely, a search by name of customers, with the token “Fran” in their name. Lexically, Fran O Connor and Francine Padeau would be ordered above Frank Swiss. However, the search result for Frank Swiss is re-ranked to be higher in relevance than the remaining search results of Block 506. The original ranking is revised, based on user context data shown in Block 512, and the knowledge graph of the user providing the search queries. In the user context data, analysis shows that the user clicks on search results showing pending amounts and unpaid amounts at a significantly higher rate than other search results. Further, analysis of the application context with respect to the user may show that the user spends most of their time on application features related to customers and payments. From the knowledge graph of the user shown in Block 510, the user connections to payments and customers are more heavily weighted than connections to invoices. Thus, the ranking of the search results are revised to bump up the result including a customer whose name has the token “Fran” and also has pending amounts of money owed to the user.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims. Please amend the Claims as follows.

1. A method comprising:
generating, by a hybrid search engine, a plurality of indexes based on a plurality of mappings, the plurality of indexes corresponding to a plurality of documents. each index of the plurality of indexes comprising a text field and an embedding field;
processing a search query with an embedding model of the hybrid search engine to obtain a search query embedding, wherein the search query is received from a user application;
performing a hybrid search by:
performing a federated search with a plurality of hybrid search engine instances to obtain a plurality of federated search results, the plurality of hybrid search engine instances performing a lexical search of the text field of the plurality of indexes with the search query and a semantic search of the embedding field of the plurality of indexes with the search query embedding, and
aggregating the plurality of federated search results to obtain a search result set;
ranking the search result set, based on hybrid search scores, user context data, and a user graph to obtain a ranked result set;
processing the ranked result set by a generative artificial intelligence (GenAI) model by summarizing the ranked result set and annotating the ranked result set with explanations of the ranking to obtain a ranking summarization;
presenting the ranked result set in the user application;
capturing, via a faceted navigation feature of the user application, user-preferred results of the ranked result set obtained by filtering the ranked result set based on user-selected facets; and
updating the user context data and the user graph based on the user-preferred results and the user-selected facets.

2. The method of claim 1, further comprising:
ingesting, in real-time, raw data from a plurality of data sources by the hybrid search engine;
generating, by the embedding model of the hybrid search engine, embeddings of the raw data, wherein the embedding model is a multi-lingual embedding model;
adding the raw data to a document, comprising data fields corresponding to the raw data and vector fields corresponding to the embeddings of the raw data, to obtain the plurality of documents;
generating, by an indexer of the hybrid search engine, a corresponding index of the plurality of documents, comprising text fields and embedding fields; and
storing the plurality of documents and the index in a hybrid search engine data store.

3. The method of claim 1, further comprising:
processing the search query with an encoder model to obtain expanded search query terms, and derived search queries; and
performing the hybrid search using the search query, the search query embedding, the expanded search query terms, and the derived search queries.

4. The method of claim 1, further comprising:
obtaining the search result set comprising lexical search results and corresponding lexical search scores, and semantic search results and corresponding semantic search scores; and
determining, by a result ranking engine, hybrid search scores of the search result set based on the corresponding lexical search scores and the corresponding semantic search scores.

5. The method of claim 1, further comprising:
extracting, by a result ranking engine, from the user context data, at least one feature of the user context data to obtain a feature set of the user context data, wherein the user context data corresponds to a user of the user application that generated the search query;
processing the feature set of the user context data by a ranking model of the result ranking engine, and outputting, by the ranking model, a scaling factor based on the feature set of the user context data; and
applying the scaling factor to hybrid search scores of the search result set to obtain scaled hybrid search scores of the search result set.

6. The method of claim 1, further comprising:
obtaining, by a graph-based adjuster of a result ranking engine, a set of first entities occurring in the search result set,
wherein the set of first entities is a subset of a set of second entities occurring in the user graph, and
wherein the user graph corresponds to a user of the user application that generated the search query; and
for each first entity in the set of first entities,
performing a connection analysis on user-to-entity connections and entity-to-entity connections of the user graph, wherein a first node of the user graph corresponds to the user, and remaining nodes of the user graph correspond to the set of second entities,
to obtain multiplying factors for the set of first entities.

7. The method of claim 6, further comprising:
applying the multiplying factors to scaled hybrid search scores of the search result set to obtain ranking scores; and
ordering the search result set based on the ranking scores to obtain the ranked result set.

8. (canceled)

9. The method of claim 1, further comprising:
fine-tuning the embedding model based on the user-preferred results, wherein the embedding model is a multi-lingual and multi-modal embedding model.

10. A system, comprising:
at least one computer processor;
a hybrid search engine, executing on the at least one computer processor;
a result ranking engine, executing on the at least one computer processor; and
a generative artificial intelligence (GenAI model), executing on the at least one computer processor,
wherein the system is configured for:
generating, by the hybrid search engine, a plurality of indexes based on a plurality of mappings, the plurality of indexes corresponding to a plurality of documents, each index of the plurality of indexes comprising a text field and an embedding field,
processing a search query with an embedding model of the hybrid search engine to obtain a search query embedding, wherein the search query is received from a user application,
performing a hybrid search by:
performing a federated search with a plurality of hybrid search engine instances to obtain a plurality of federated search results, the plurality of hybrid search engine instances performing a lexical search of the text field of the plurality of indexes with the search query and a semantic search of the embedding field of the plurality of indexes with the search query embedding, and
aggregating the plurality of federated searches results to obtain a search result set,
ranking the search result set with the result ranking engine, based on hybrid search scores, user context data, and a user graph to obtain a ranked result set,
processing the ranked result set by the GenAI model by summarizing the ranked result set and annotating the ranked result set with explanations of the ranking to obtain a ranking summarization,
presenting the ranked result set in the user application,
capturing, via a faceted navigation feature of the user application, user-preferred results of the ranked result set obtained by filtering the ranked result set based on user-selected facets, and
updating the user context data and the user graph based on the user-preferred results and the user-selected facets.

11. The system of claim 10, further configured for:
ingesting, in real-time, raw data from a plurality of data sources, by the hybrid search engine;
generating, by the embedding model of the hybrid search engine, embeddings of the raw data, wherein the embedding model is a multi-lingual embedding model;
adding the raw data to a document, comprising data fields corresponding to the raw data and vector fields corresponding to the embeddings of the raw data, to obtain the plurality of documents;
generating, by an indexer of the hybrid search engine, a corresponding index of the plurality of documents, comprising text fields and embedding fields; and
storing the plurality of documents and the index in a hybrid search engine data store.

12. The system of claim 10, further configured for:
processing the search query with an encoder model of the GenAI model to obtain expanded search query terms, and derived search queries; and
performing the hybrid search using the search query, the search query embedding, the expanded search query terms, and the derived search queries.

13. The system of claim 10, further configured for:
obtaining the search result set comprising lexical search results and corresponding lexical search scores, and semantic search results and corresponding semantic search scores; and
determining, by the result ranking engine, hybrid search scores of the search result set based on the corresponding lexical search scores and the corresponding semantic search scores.

14. The system of claim 10, further configured for:
extracting, by the result ranking engine from the user context data, at least one feature of the user context data to obtain a feature set of the user context data, wherein the user context data corresponds to a user of the user application that generated the search query;
processing the feature set of the user context data by a ranking model of the result ranking engine, and outputting, by the ranking model, a scaling factor based on the feature set of the user context data; and
applying the scaling factor to hybrid search scores of the search result set to obtain scaled hybrid search scores of the search result set.

15. The system of claim 10, further configured for:
obtaining, by a graph-based adjuster of the result ranking engine, a set of first entities occurring in the search result set,
wherein the set of first entities is a subset of a set of second entities occurring in the user graph, and
wherein the user graph corresponds to a user of the user application that generated the search query; and
for each first entity in the set of first entities,
performing a connection analysis on user-to-entity connections and entity-to-entity connections of the user graph, wherein a first node of the user graph corresponds to the user, and remaining nodes of the user graph correspond to the set of second entities,
to obtain multiplying factors for the set of first entities.

16. The system of claim 15, further configured for:
applying the multiplying factors to scaled hybrid search scores of the search result set to obtain ranking scores; and
ordering the search result set based on the ranking scores to obtain the ranked result set.

17. The system of claim 10, further configured for:
performing the hybrid search by:
performing the federated search with the plurality of hybrid search engine instances, to obtain the plurality of federated search results, and
aggregating the plurality of federated search results to obtain the search result set.

18. The system of claim 10, further configured for:
fine-tuning the embedding model based on the user-preferred results, wherein the embedding model is a multi-lingual and multi-modal embedding model.

19. A method for ranking a set of search results, comprising:
generating, by a hybrid search engine, a plurality of indexes based on a plurality of mappings, the plurality of indexes corresponding to a plurality of documents. each index of the plurality of indexes comprising a text field and an embedding field;
processing a search query with an embedding model of the hybrid search engine to obtain a search query embedding, wherein the search query is received from a user application and generated by a user;
performing a hybrid search by:
performing a federated search with a plurality of hybrid search engine instances to obtain a plurality of federated search results, the plurality of hybrid search engine instances performing a lexical search of the text field of the plurality of indexes with the search query to obtain lexical search results and corresponding lexical search scores and a semantic search of the embedding field of the plurality of indexes with the search query embedding to obtain semantic search results and corresponding semantic search scores, and
aggregating the plurality of federated search results to obtain a search result set;
determining, by a result ranking engine, hybrid search scores of the search result set based on the corresponding lexical search scores and the corresponding semantic search scores;
extracting, by the result ranking engine, from user context data, at least one feature of the user context data to obtain a feature set of the user context data, wherein the user context data corresponds to the user that generated the search query;
processing the feature set of the user context data by a ranking model of the result ranking engine, and outputting, by the ranking model, a scaling factor based on the feature set of the user context data;
applying the scaling factor to the hybrid search scores of the search result set to obtain scaled hybrid search scores of the search result set;
obtaining, by a graph-based adjuster of the result ranking engine, a set of first entities occurring in the search result set,
wherein the set of first entities is a subset of a set of second entities occurring in a user graph, and
wherein the user graph corresponds to the user of the user application that generated the search query;
for each first entity in the set of first entities,
performing a connection analysis on user-to-entity connections and entity-to-entity connections of the user graph, wherein a first node of the user graph corresponds to the user, and remaining nodes of the user graph correspond to the set of second entities, to obtain multiplying factors for the set of first entities;
applying the multiplying factors to the scaled hybrid search scores of the search result set to obtain ranking scores;
ordering the search result set based on the ranking scores to obtain a ranked result set; and
processing the ranked result set by a generative artificial intelligence (GenAI) model by summarizing the ranked result set and annotating the ranked result set with explanations of the ranking to obtain a ranking summarization.

20. (canceled)
